(19) United States
(12) Patent Application Publication
(10) Pub. No.: US 2009/0072142 A1
(43) Pub. Date: Mar. 19, 2009

(54) Scanning system and techniques for medical and/or forensic assessment using the same

(75) Inventor: Herbert L. Blitzer, Indianapolis, IN (US)

Correspondence Address: KRIEG DEVAULT LLP, ONE INDIANA SQUARE, SUITE 2800, INDIANAPOLIS, IN, 46204-2079, US

(73) Assignee: ForensiCARE Incorporated

(21) Appl. No.: 11/901,181

(22) Filed: Sep. 14, 2007

(51) Int. Cl. G01J 1/42

(52) U.S. Cl. 250/338.1; 250/216; 250/372

(57) ABSTRACT

A data recording system for scanning tissues of human beings or other objects from crime scenes includes a hand-held scanner and computer. The scanner has a housing including a platen along the bottom surface of the housing, a scanning mechanism including an illumination source and sensor positioned within the housing under a platen, a control unit, memory for storing data files, and disposable spacers removably attached to the bottom surface of the housing that hold the scanner a predetermined distance from the tissue or object. The scanner is placed over the tissue or object and emits light from the illumination source there toward. A predetermined range of light wavelengths reflected by the object is sensed by sensors and sensor signals are generated corresponding thereto. The controller processes the sensor signals and stores them as a data file in the memory for use in medical and crime scene analysis.

### BACKGROUND

The present invention relates to data processing systems, and more particularly, but not exclusively, relates to a data recording system used to scan the outer surface of a patient's body and store the data to document the patient's condition.

In certain applications, it is desirable to monitor tissue conditions by conducting a visual examination of parts of an animal or human body. In one instance, wounds or other conditions affecting the patient's skin are monitored to assist with medical diagnosis and/or to establish a baseline condition for later reference. In current practice, a nurse or attending physician typically documents visual observations involving the skin in writing and/or by voice recording. On occasion, a digital camera, video camera, or other photographic tool may be used.

Unfortunately, such devices are often unable to acquire images of a type suitable to desirably monitor changes over time and/or perform desired diagnostics. Thus, there is an ongoing demand for further contributions in this area of technology.

### SUMMARY

One embodiment of the present invention includes unique techniques involving application of a scanner to gather data about the outer surface of a person and/or object for medical and/or forensic evaluation. Other embodiments include unique methods, systems, devices, and apparatus involving data processing systems. Further embodiments, forms, features, aspects, benefits, and advantages of the present application shall become apparent from the description and figures provided herewith.

### BRIEF DESCRIPTION OF THE DRAWING

FIG. 1 is a diagrammatic view of a data recording system applied to a human body.

FIG. 2 is a perspective side view of one form of a scanner included in the system of FIG. 1.

FIG. 3 is a bottom view of the scanner depicted in FIG. 2.

FIG. 4 illustrates certain operational aspects of certain components of the scanner depicted in FIG. 2.

FIG. 5 is a block diagram illustrating certain components of the scanner illustrated in FIG. 2 and system illustrated in FIG. 1.

FIG. 6 is a perspective view of a cup-shaped bumper.

FIG. 7 is a perspective view of a cup-shaped scanner.

FIG. 8 is a flowchart directed to an exemplary application of the system of FIG. 1.

FIG. 9 is a partially schematic, top view of an alternative system for gathering image data.

FIG. 10 is a partially schematic top view of a representative imaging subsystem included in the system of FIG. 9.

FIG. 11 is a partially schematic side view of the representative imaging subsystem shown in FIG. 10.

### DETAILED DESCRIPTION OF REPRESENTATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

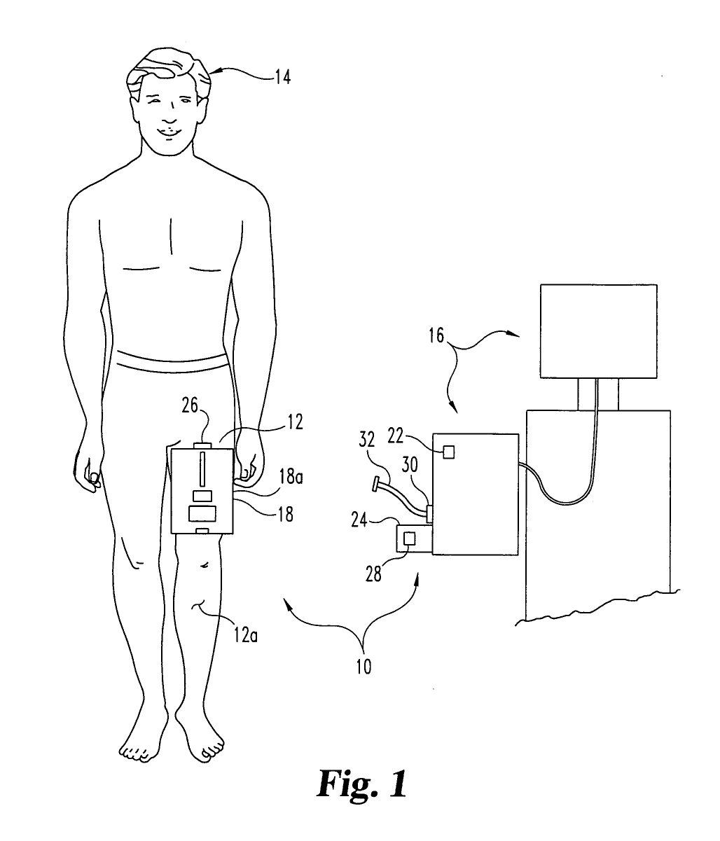

FIG. 1 illustrates a data recording system 10 that is utilized to scan a predefined area of tissue 12 or skin 12a of an animal or human body 14. System 10 may also be utilized to scan objects, such as hand prints or blood splatter patterns at a crime scene, to name a few alternatives. By way of nonlimiting example, system 10 will be described in conjunction with scanning the skin 12a of a human body 14 for the sake of brevity.

System 10 includes a storage system 16, which in one form comprises a computer or data processing unit 16, and a hand-held digital image capturing device 18 in the form of a scanner 18a. Scanner 18a is operable to scan areas of tissue 12 and communicate data obtained by the scanning process to computer 16. Scanner 18a is portable and is placed in proximity with the area of tissue 12 to be scanned during operation so that data representative of the tissue 12 may be captured by scanner 18a. Scanner 18a is capable of obtaining a color image, an infrared image, and an ultraviolet image of the tissue 12.

Scanner 18a may communicate data to the computer 16 in a number of ways. In one form, scanner 18a includes a wireless communication device or port 20 that is operable to conduct wireless communication with a wireless communication device or port 22 in computer 16. The wireless communication devices 20, 22 may be radio frequency (RF) transceivers, infrared transceivers, or other wireless communication devices.

In another form, scanner 18a may include an output port 26 that is used to communicate data files to the computer 16. The output port 26 may be a universal serial bus port (“USB port”), a serial port, a parallel port, a firewire connector, or the like. The output port 26 may connect with a corresponding mating input port 30 of computer 16 via a cable 32, a cradle like that used with a PDA or a docking station 24 in order to transmit the data files to computer 16. In one form, the docking station 24 is electrically coupled to the computer 16. In other forms, the docking station 24 may communicate wirelessly with the computer 16. In yet another form, docking station 24 may include a charging circuit 28 that is utilized to charge a rechargeable power source used to power scanner 18a. In still other forms, docking station 24 may include a printing element to print images generated from the data files.

Computer 16 receives the data files and processes the data files to generate images. The data corresponds to image information that could be in any of a number of forms, such as raw data, JPEG format, TIFF format, BMP format, or the like. Furthermore, the data can include metadata elements, such as a date and/or time stamp for the image information; equipment settings such as f-stop, exposure level, and/or other equipment parameters of interest; identification of the equipment operator; and identification of the image source, such as the name of an individual whose tissue 12 or skin 12a is imaged. It should be appreciated that scanner 18a may also be capable of processing the data files to generate images and display them. Computer 16 may include a three-dimensional (3D) image rendering software package that processes the data files to form 3D images of the scanned tissue 12. Computer 16 may also include other software packages that allow the user to superimpose images generated from the data files.

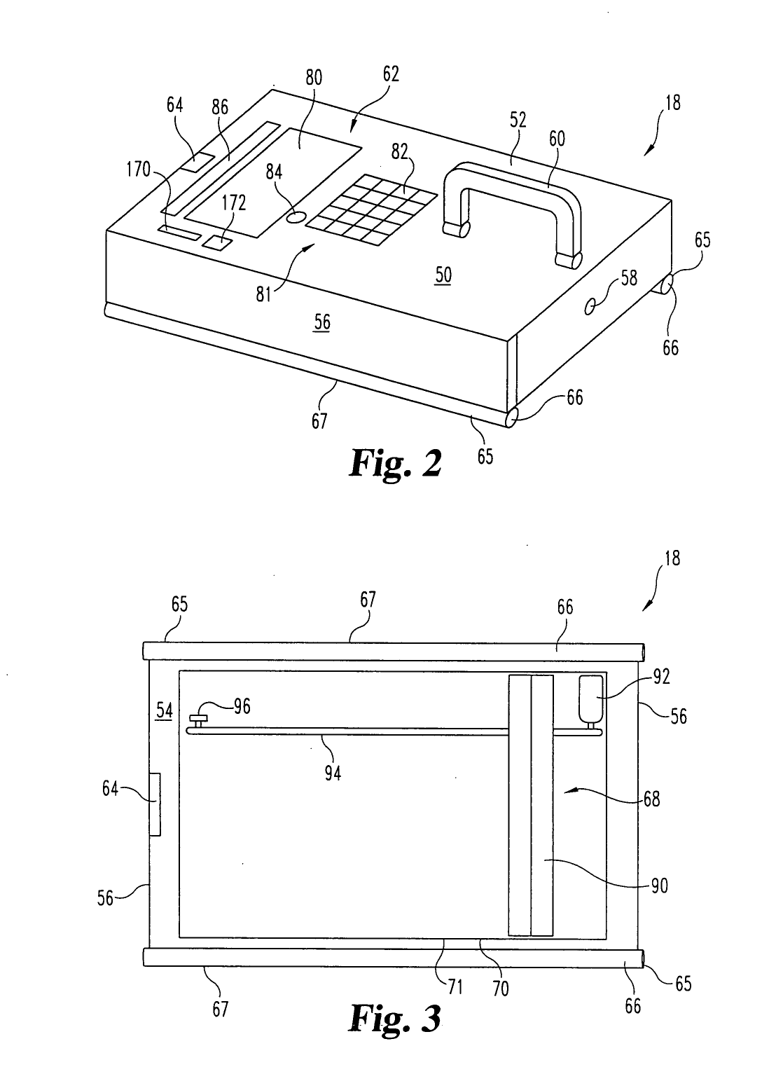

FIGS. 2 and 3 illustrate scanner 18a according to one form of the current invention. Scanner 18a includes a housing 50 having a top surface 52, a bottom surface 54, and side surfaces 56 extending between the edges of top surface 52 and bottom surface 54. Scanner 18a also includes a power switch 58, a handle 60, a user interface 62, a positioning element 64, a plurality of spacers 65, such as disposable rubber bumpers 66 or the like removably connected with bottom surface 54, and a scanning mechanism 68. Housing 20 is generally hollow and may be composed of plastic. It should be appreciated that housing 50 may be composed of other rigid or semi-rigid compounds as may occur to one skilled in the art. Handle 60, user interface 62, and positioning element 64 are attached to and visible from top surface 52 of housing 50. Handle 60 allows a user to carry and position scanner 18a in proximity to the tissue 12.

Bottom surface 54 of scanner 18a includes a transparent flat platform, glass plate or platen 70 that defines an optical window 71 through which optical image information can be sensed. It should be appreciated that while optical window 71 is comprised of a transparent solid structure, in other implementations, optical window 71 may be provided by an aperture or opening without a structural element. Scanning mechanism 68 is positioned within housing 50 under platform 70. During operation, light emitted from scanning mechanism 68 passes through platen 70 to illuminate the tissue 12 being scanned by scanner 18a. In one form, scanner 18a is capable of scanning an area of tissue 12 approximately equal to about seven inches by nine inches, but scanner 18a may be designed to scan other sized tissue areas as well. Although scanner 18a is illustrated having a generally rectangular shape, it should be appreciated that other shapes are envisioned.

Switch 58 is located on a respective side surface 56 of housing 50 and may be a single-pole single-throw switch or other switch as may occur to one skilled in the art. It should be appreciated that switch 58 may be incorporated into user interface 62 or handle 60. In one form, switch 58 is used to turn scanner 18a on and off. It should also be appreciated that switch 58 may be used to initiate a scan of the tissue 12. However, as set forth in greater detail below, user interface 62 may be used to initiate a scan of the tissue 12 in other forms.

User interface 62 includes an input device 81 in the form of a keypad 82 and a display 80. User interface 62 allows a user to view the data files and/or enter information related to the scanned data. For example, input device 81 can be used to enter metadata, such as a name or other identifier of the equipment operator, the individual being imaged, miscellaneous comments regarding the imaging, or the like. In other forms, input device may 81 be a microphone 84, a stylus 170 and a stylus pad 172, and/or a barcode scanner 86. Supplemental data entered through the user interface 62 may be stored as metadata accompanying the data files.

Keypad 82 is used to enter identifying data files associated with the patient or person being scanned as well as any other pertinent data that may need to be associated with the data files (e.g.—date, time, location, part of body, user performing scan, and so forth), while display 80 visually displays the data being entered. In one form, the keypad 82 is a number pad and the display 80 is a liquid crystal display (“LCD”). In other forms, keypad 82 is a standard QWERTY keyboard and display 80 is selected from a vacuum fluorescent display (“VFD”), a light emitting diode (“LED”) display, a Cathode Ray Tube (CRT) display, electroluminescent display (“ELD”), a plasma display, but other keypads and displays may be used as may occur to one skilled in the art. In still other forms, the keypad 82 may be incorporated into display 80 in the form of a touch screen keypad.

Microphone 84 is used to store voice data or notes that are recorded by the user of the scanner 18a during an examination. The user may initiate a recording through the user interface 62 to record messages via the microphone 84 and store them in scanner 18a. The recorded voice files or messages may be stored using one of several digital audio file formats such as, for example, wav, mp3, ogg, gsm, gsm, dct, aif, and so forth.

Barcode scanner 86 is utilized to identify users of scanner 18a. For example, when a nurse or attending physician is using scanner 18a, they can identify themselves as the individual using scanner 18a at that time by placing a card having a barcode thereon over barcode scanner 86, which will cause scanner 18a to identify all data obtained by scanner 18a to be associated with that particular individual. In other forms, barcode scanner 86 may be used to scan the wristband or chart of the person being scanned, which will cause scanner 18a to identify all data obtained by scanner 18a to be associated with that particular individual.

Positioning element 64 provides a reference of the physical location and orientation of scanner 18a with respect to the tissue 12 being scanned. Positioning element 64 is located on a side surface 56 of housing 50. It should be appreciated that positioning element 64 may be removable from housing 50. In other forms, positioning element 64 may mark the tissue 12 to indicate the physical location and orientation of scanner 18a.

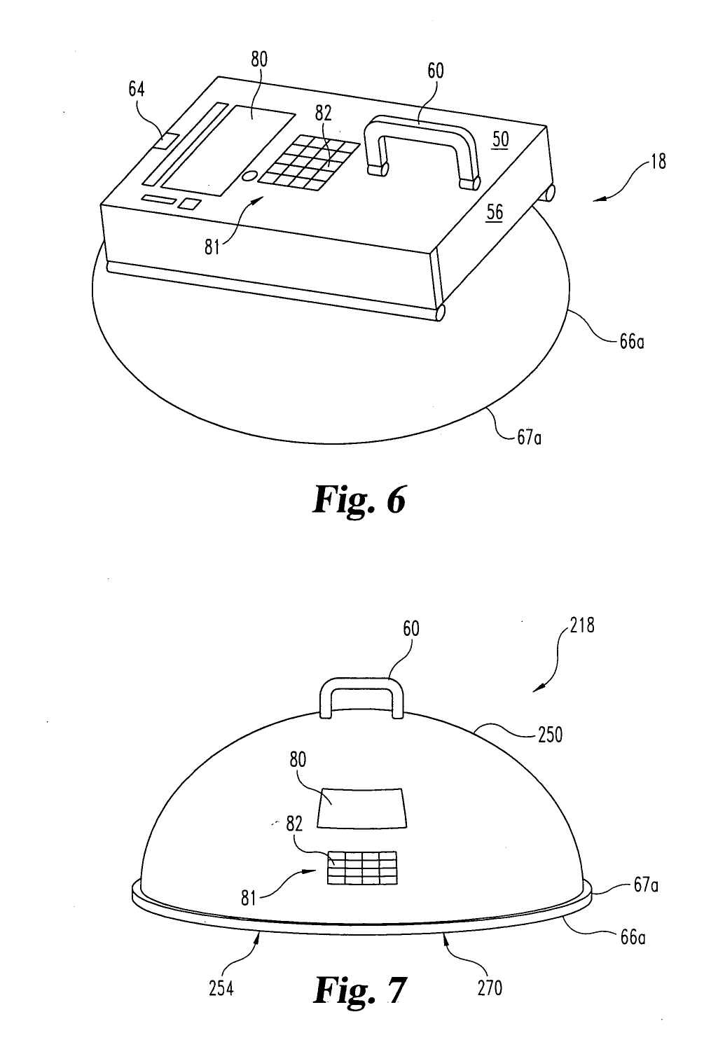

Bumpers 66 are removably coupled with the outer edges of bottom surface 54 to contact skin 12a and maintain bottom surface 54 a predetermined distance away from a corresponding region thereof—preventing bottom surface 54 and platen 70 from making contact with the tissue 12/skin 12a. Bumpers 66 may also seal scanner 18a to the tissue 12 to prevent the tissue 12 from being exposed to ambient light during the scanning process. In the event that contamination of bottom surface 54 and platen 70 occurs, scanning surface 54 and platen 70 may be cleaned with cleanser or ultraviolet light. Bumpers 66 also serve as a boundary for the area to be scanned and may include scalar markings thereon to indicate size. Bumpers 66 may be tube-shaped and composed of a semi-rigid material, such as foam or rubber. It should be appreciated that other rigid or semi-rigid materials may be used as may occur to one skilled in the art. FIG. 6 illustrates a spacer 66a according to another embodiment where the spacer 66a is cup-shaped for use with elbow joints, knee joints, or other curved surfaces. It should be appreciated that bumpers 66 (as well as spacers 65 and 66a) define barrier 67 that at least partially shields a region of skin 12a from illumination by ambient light external to the corresponding imaging device when applied as shown in FIG. 1.

Referring to FIG. 3, scanning mechanism 68 is retained within the housing 50 beneath platen 70 and in this form includes a scan head 90, a stepper motor 92, a belt 94, and a gear 96. Stepper motor 92 is used to drive scan head 90 across platen 70 during a scanning operation. Belt 94 is connected with scan head 90 and engages stepper motor 92 and gear 96. Upon energizing or initiating stepper motor 92, belt 94 is moved by stepper motor 92 causing gear 96 to be rotated and scan head 90 to traverse back and forth across platen 70 so that scanning mechanism 68 can scan an area of tissue 12. In one form, user interface 62 or switch 58 can be used to disengage stepper motor 92 during a scanning process thereby allowing a user to manually move scanner 18a across the tissue 12 to obtain a scan. In another form, scanning mechanism 68 is fixedly secured in housing 50 beneath platform or platen 70 and scan head 90 is not driven by stepper motor 92. In this form, the user moves scanner 18a across the tissue 12 of the patient manually to obtain a scan.

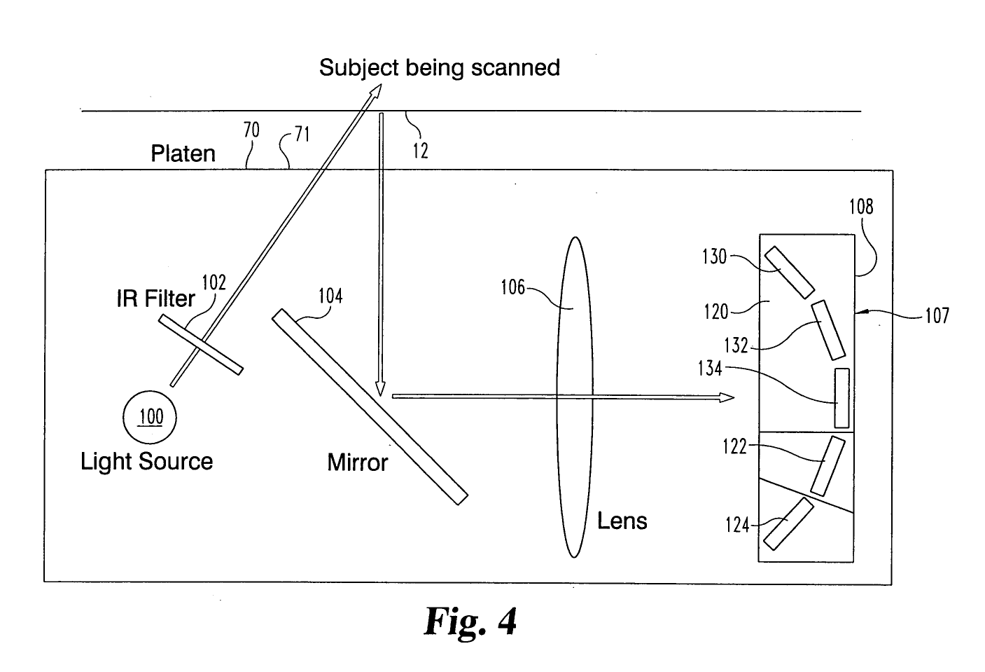

Referring to FIG. 4, scan head 90 of scanning mechanism 68 includes an illumination or light source 100, an infrared filter 102, at least one mirror or light reflection device 104, a lens 106, and an image sensor arrangement 107 including at least one sensor 108. Scanner 18a acquires data for tissue 12 by sensing light that is reflected off of the tissue 12. Light source 100 is used to generate the light that is reflected off tissue 12. In one form, light source 100 is operable to simultaneously emit multiple wavelengths of light including ultraviolet light and visible light. Light source 100 may be a cold cathode bulb, a fluorescent lamp or bulb or a dense bank of red, green, and blue light emitting diodes (“LEDs”) that is operable to produce white light. In another form, light source 100 comprises any light source, or combination of light sources, that is operable to emit light.

In cooperation with bumper 66, light source 100 provides uniform and repeatable lighting relative to the target such that light source position, intensity, composition, or the like can be reproduced from one application to the next. Unlike standard imaging data gathering techniques applied with a camera or the like, such uniform lighting eliminates variables that tend to complicate, if not obfuscate, changes in skin condition or the like. Further, scanner 18a provides for a controlled consistent size of the target image area via the uniform separation distance between the skin 12a and equipment (such as image sensor arrangement 107). Moreover, with a uniform scanning technique, the image data can be readily compared to identify any differences in condition over time.

Infrared filter 102 is positioned between light source 100 and tissue 12 to remove any unwanted infrared light that is generated by light source 100. As set forth in greater detail below, in addition to acquiring data able to be processed into a digital color image of tissue 12, scanner 18a is also operable to acquire data able to be processed into a digital image of tissue 12 that is indicative of the temperature of specific areas of tissue 12, i.e., a digital thermal image of the area of tissue 12 based on tissue-emitted infrared. In order to obtain accurate temperature readings, infrared filter 102 is used to remove infrared light contained in the light that is directed toward the area of tissue 12 from light source 100.

Light that is directed toward the tissue 12 from light source 100 reflects off of the tissue 12 toward mirror 104. Mirror 104 directs the reflected light to lens 106. Lens 106 focuses the reflected image onto sensor 108. In one form, sensor 108 comprises a charged coupled device (“CCD”). CCDs contain an array of photosensitive cells that react to incoming light based on its properties, such as intensity and color. During the scanning process, CCDs capture the incoming light sent from lens 106, and then generate various analog signals that correspond to the incoming light properties. In another form, sensor 108 comprises a contact image sensor (“CIS”). This type of sensor has the same function as a CCD except it does not require the use of a lens 106 to concentrate the light source and is generally smaller in size. In still other forms, complimentary metal oxide semiconductor (CMOS) technology and/or different sensor types known to those skilled in the art may be utilized.

In another representative form, sensor 108 includes a visible light or color sensor 120, infrared sensor 122, and ultraviolet light sensor 124 and is configured to simultaneously detect multiple wavelengths of light reflected by tissue 12. Color sensor 120 is utilized to acquire data able to be processed into a digital color image of the tissue 12 being scanned; the infrared sensor 122 is utilized to acquire data able to be processed into a thermal image of the area of tissue 12 being scanned; and the ultraviolet light sensor 124 is utilized to acquire data able to be processed into an ultraviolet light image of the area of tissue 12 being scanned. The ultraviolet light image of the tissue 12 that is scanned is utilized to help identify certain surface contaminates or read some sub-coetaneous features of the tissue 12. Color sensor 120 may comprise a CCD sensor, a CIS sensor, or such other sensor type as would occur to those skilled in the art. In alternative forms, color sensor 120 may include one or more sensing elements for different light wavelengths or light spectrum ranges, such as a red light sensor 130, a green light sensor 132, and/or a blue light sensor 134.

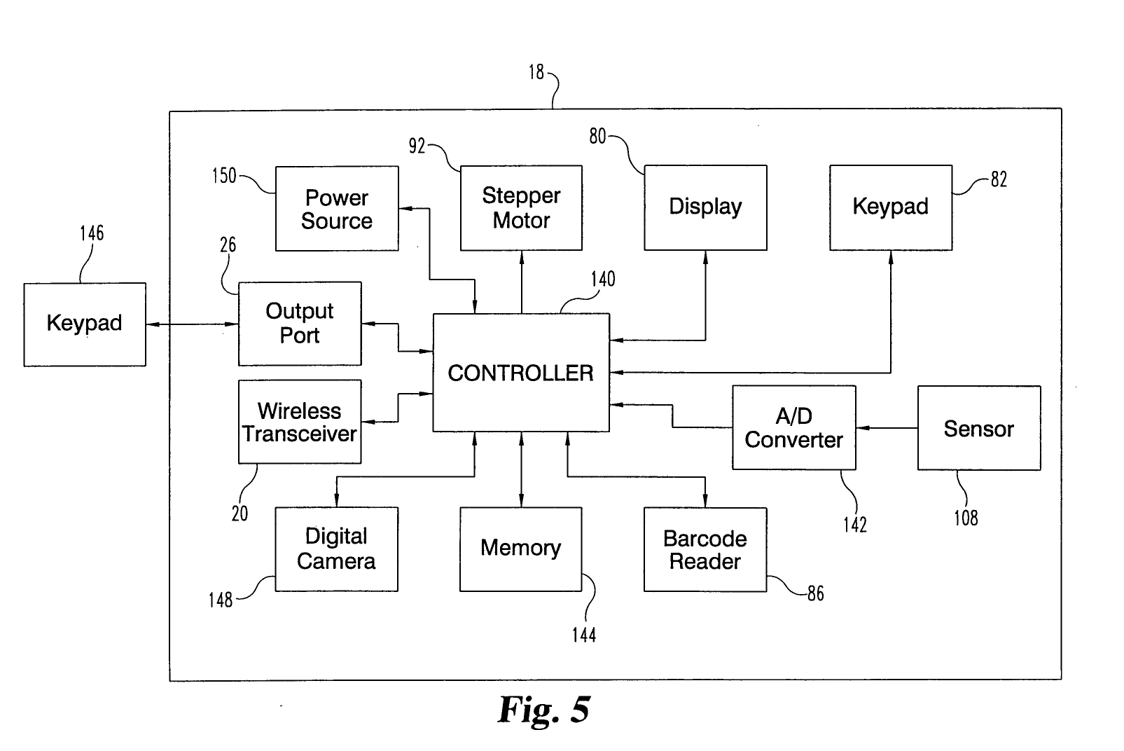

Referring to FIG. 5, as set forth above, scanner 18a includes sensor 108 that is electrically coupled to an input of an analog to digital (“A/D”) converter 142. The A/D converter 142 is operable to take analog signals generated by sensor 108 and convert them into digital signals. An output of A/D converter 142 is coupled to a controller 140, which may comprise a microprocessor, or any other type of suitable digital signal processor.

As set forth above, controller 140 executes operating logic that defines various control, processing, and/or communication functions. This operating logic may be in the form of dedicated hardware, such as a hardwired state machine, programming instructions, and/or a different form as would occur to those skilled in the art. Controller 140 processes scan signals produced by the sensor 108 into data that is stored as data files. The data is able to be processed into images of the skin 12a including color images, monochromatic images, 3D images, thermal images, and ultraviolet images. 3D images may be acquired through multiple techniques including Wiener Filtering, 2½D scanning, angled laser scanning, having two color sensor rows at the ends a sensor array to be read in a way that allows computation of surface elevation, or through 3D image rendering software provided on computer 16 as previously described. Furthermore, it should be appreciated that programs and processes executed by controller 140 and computer 16 can be differently distributed among them in other implementations. By way of nonlimiting example, image data compression may be executed by either processing device and/or shared between them in some fashion. In still other examples, only one processing unit may be utilized with the other being absent.

Controller 140 may be provided as a single component or a collection of operatively coupled components; and may be comprised of digital circuitry, analog circuitry, or a hybrid combination of both of these types. In one form, controller 140 is a programmable microprocessing device of a solid-state, integrated circuit type that includes one or more processing units and memory. Controller 140 can include one or more signal conditioners, modulators, demodulators, Arithmetic Logic Units (ALUs), Central Processing Units (CPUs), limiters, oscillators, control clocks, amplifiers, signal conditioners, filters, format converters, communication ports, clamps, delay devices, memory devices, and/or different circuitry or functional components as would occur to those skilled in the art to perform the desired communications.

Wireless communication device 20 of scanner 18a is connected with controller 140. Controller 140 includes computer programmable code that is operable to control the wireless transmission of data files to computer 16. In addition, output port 26 of scanner 18a is also connected with controller 140. Controller 140 includes computer programmable code that is operable to control the transmission of data files from output port 26 to computer 16. In alternative forms, output port 26 is connected with an external printer 146 that is operable to print the data files obtained from one or more scanning processes. In addition, wireless transceiver 20 is used in some forms to transmit data files to an external printer 146 operable to print the color images obtained from the various scanning processes.

Display 80 and keypad 82 are connected with controller 140. Controller 140 is used to drive display 80 and receive data inputs from keypad 82. A digital camera 148 is also connected with controller 140. Digital camera 148 is operable to take digital photographs of the tissue 12. Unlike scanning mechanism 68, digital camera 148 is capable of taking larger photographs of areas of interest and is also capable of zooming in and out with respect to certain areas of the human body 14. Typically, digital images taken with camera 148 are for use as positioning or establishment shots. Digital photographs taken by digital camera 148 are stored in memory 144, may be printed on printer 146, or uploaded or transferred to computer 16.

A memory storage device or memory 144 is coupled to controller 140. Memory 144 may be flash memory or other forms of memory such as a hard disk drive, Electrically-Erasable Programmable Read-Only Memory (EEPROM), Erasable Programmable Read-Only Memory (EPROM), optical disk, or other non-volatile or volatile memory storage devices. Memory 144 is used to store the digital scanned image data taken by scanner 18a. In particular, memory 144 is used to store digital color picture images or scans, digital color thermal images or scans, and digital ultraviolet images or scans. Controller 140 may save the digital scanned images in one of several digital file formats, such as for example, raw files, jpg files, tiff files, gif files, bmp files, and/or psd files. Operating logic of computer 16 is provided to recognize the format provided by controller 140 and apply further processing as previously described. Also, as previously indicated, processing tasks may be distributed differently among controller 140 and computer 16. In addition, memory 144 is also used to store information relating to the digital scanned images that is entered using user interface 62 as well as the digital audio files that may be entered using microphone 84. Memory 144 may be accessed through user interface 68 or computer 16. Controller 140 controls such access in some forms and/or computer 16 controls such access in other forms.

Power source 150 is connected to the controller 140 and is used to drive or supply energy to various components of scanner 18a. In one form, power source 150 comprises a rechargeable lithium ion battery. It should be appreciated that power source 150 may also be an alkaline battery, a lithium battery, a lithium composite battery, a lead acid core battery, nickel metal hydride battery, or any other rechargeable or non-rechargeable batteries. Voltage conditioning circuitry may be used to raise or lower the amount of power supplied to each respective component.

In operation, scanner 18a is powered on via switch 58 and positioned proximate tissue 12 to be scanned such that bumpers 66 contact tissue 12. Positioning element 64 generates a physical location and orientation reference for scanner 18a with respect to the tissue 12. A scan is initiated through user interface 62 which causes light source 100 to illuminate tissue 12 with multiple wavelengths of light. Light source 100 is moved along tissue 12 to obtain data representative of tissue 12. As previously set forth, in other forms light source 100 remains stationary within housing 50 while scanner 18a is moved manually by a user. During the scanning process, sensor 108 detects a predetermined range of wavelengths of light that are reflected by tissue 12. Sensor 108 generates signals corresponding to the light sensed and communicates the signals to the controller 140. Controller 140 processes the signals received by sensor 108 into data that is stored as data files in memory 144. The data files remain in memory 144 until it is communicated to computer 16 or printer 146 for analysis. Once the scan process is completed, bumpers 66 are removed and disposed of and new bumpers 66 are attached to scanner 18a.

FIG. 7 illustrates another form of digital image capturing device in the form of hand-held scanner 218; where like reference numerals refer to like features previously described. In this form, scanner 218 is formed having a generally cup-shaped bottom surface 254 and platen 270. Scanned images taken by this scanner 218 may have a generally circular or oval shape. This form of the present invention is designed for use in connection with joints of the human body that have a generally oval or circular configuration.

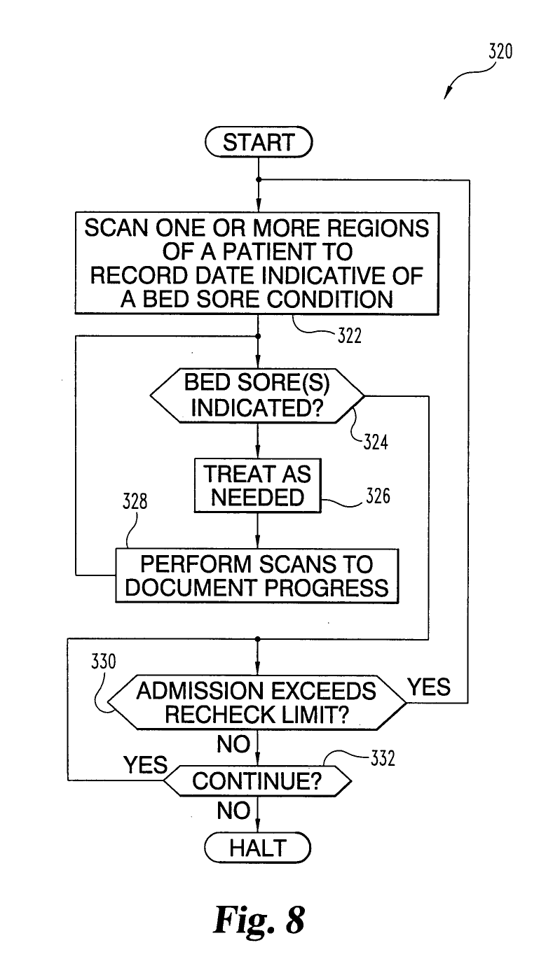

FIG. 8 depicts procedure 320 in flowchart form. Procedure 320 begins with operation 322 in which a patient is initially checked for a bed sore condition by applying scanner 18a to one or more body regions of the patient that are frequently subject to bed sores. These locations tend to be articulating joints in contact with a bed surface such as elbows, heels, and the like. Software can be utilized to provide data to establish uniform documentation of these curved surfaces. Alternatively or additionally, the cup-shaped embodiment of FIG. 6 could be used to better compliment the shape of such locations.

The data resulting from operation 322 is stored in memory 144 and sent to system 10, establishing a record of the bed sore condition at that time. From operation 233, procedure 320 continues with test 324, which determines if one or more bed sores are indicated. If so, then treatment occurs in operation 326 and rescanning is performed in operation 328 one or more times to document such treatment. Procedure 320 then returns to test 324 until bed sores have been addressed.

Once/if test 324 is negative, then procedure 320 continues with test 330. Test 330 determines whether a threshold period of time has lapsed since the last scan for bed sores. If so, then, procedure 320 returns to operation 322 to repeat the scan. The resulting data is stored to provide a record documenting bed sore status. If the test of 330 is negative, then test 332 is reached to determine if procedure 320 should continue—such as whether the patient's care requires such a procedure. If the test is to continue, then procedure 320 returns to repeat tests 330 and 332 until there is a change in the status of one or the other. If test 332 is negative, then procedure 320 halts.

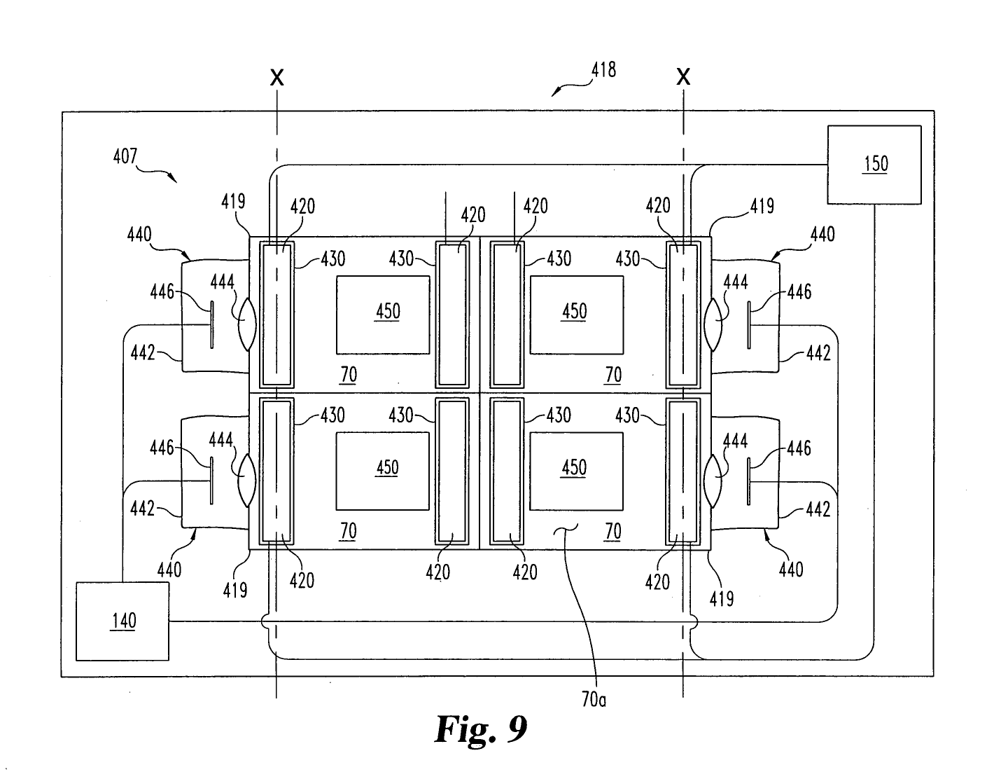

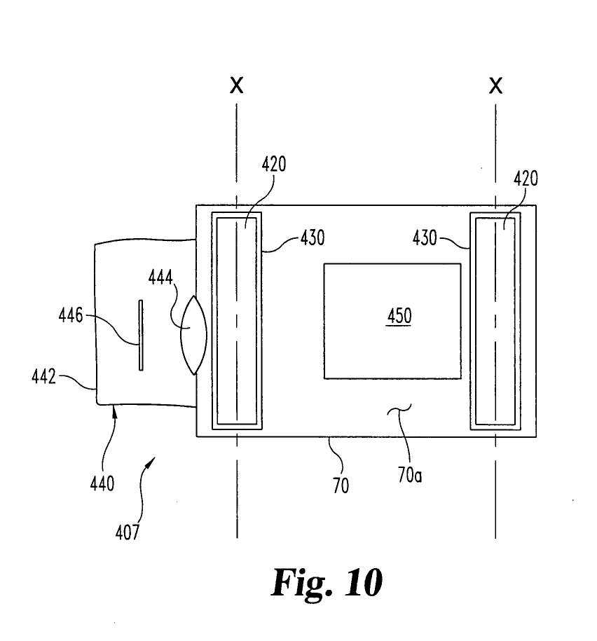

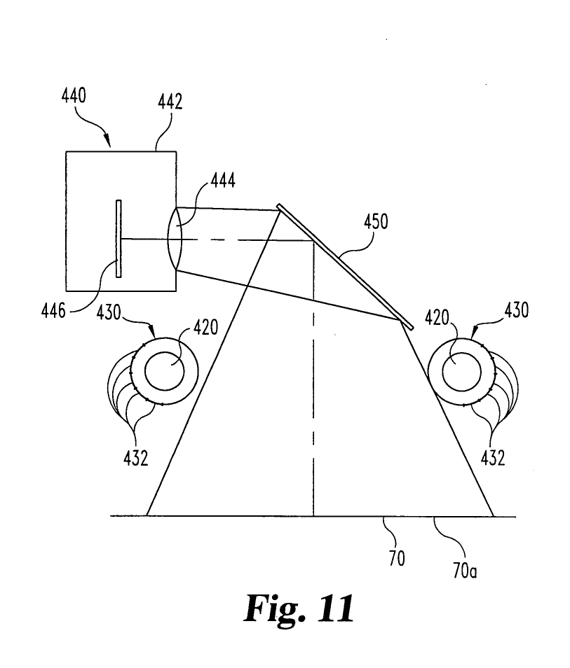

FIGS. 9-11 illustrate a digital image capturing device 418 according to another form of the present invention; where like reference numerals refer to like features previously described. Device 418 may be used in lieu of or in addition to scanner 18a and/or 218 to execute procedure 320 and/or such other operations as contemplated herein. Device 418 provides an image sensing arrangement 407 that includes a number of camera assemblies 419 (four are specifically shown). Each assembly 419 includes two controlled light sources 420 each within a corresponding adjustable filter 430, a camera enclosure 442, lens 444, mirror 450 to at least partly define an optical pathway of the respective assembly 419 (see, for example, FIG. 11), and optical imaging sensor 446. Assemblies 419 are positioned within a respective housing 50 along platen 70. Each assembly 419 is alternatively designated as camera 440. In other embodiments (not depicted), it should be appreciated more or fewer cameras, camera assemblies, light sources, filters, mirrors, lenses, enclosures, sensors, or the like can included.

Each camera 440 is operatively coupled to a controller 140 to process and store input from sensors 446 and to control operation of light sources 420 and filters 430. Each camera 440 is electrically coupled with power source 150. Light sources 420 each emit wavelengths of light in the visible and/or ultraviolet light spectrums, and are synchronized with cameras 440 by controller 140 to provide illumination of the target (such as skin 12a) in a coordinated fashion through platen 70, which is in the form of an optically transparent window 70a. Furthermore, device 418 is arranged with one or more appropriate bumpers/spacers to prevent intrusion of ambient light during imaging, such that illumination with sources 420 is controlled to provide uniform and repeatable imaging results.

In the depicted form, filter 430 is generally a hollow right circular cylinder that is secured in housing 50 with a corresponding light source 420 positioned therein. Filter 430 is operable to controllably rotate about its corresponding rotational axis X (a couple of which are specifically shown). Axis X is approximately parallel to platen 70 and the rotational axes of the other filters 430. Filter 430 includes multiple filter elements 432, such as, an ultraviolet light passing filter, red light passing filter, blue light passing filter, and green light passing filter. Filter elements 432 are generally incorporated in the surface of filter 430. It should be appreciated that filter elements 432 may be arranged to form a hollow cylinder within filter 430 such that only one of filter elements 432 is positioned proximate an opening in the filter 430 when filter elements 432 are rotated about axis X of filter 430. It should also be appreciated that filter 430 may rotate about axis X while filter elements 432 remain stationary.

In one implementation, cameras 440 are of a type typically used to store still images under daylight conditions, such as the digital camera configurations commonly included in cell phones. In operation, lenses 444 direct the light reflected by the skin 12a toward the respective sensor 446. Sensor 446 includes the ability to detect image information with respect to infrared, ultraviolet, and visible light ranges. Sensor 446 is electrically coupled to controller 140 and sends signals corresponding to the light detected by sensor 446 to controller 140. Controller 140 operates to control the exposure of the sensor 446 to the light reflected by the skin 12a via mirror 450, and receive signals from the sensor 446. It should be appreciated that controller 140 may control the exposure of the sensor 446 by electronically and/or mechanically adjusting the size of the opening into the camera and the amount of time the reflected light can pass through the opening. It should also be appreciated that controller 140 may control the distance to lens 444 to focus the appropriate amount of light reflected by the skin 12a on sensor 446.

Cameras 440 are positioned relative to platen 70 such that each corresponds to a different unique region to gather corresponding regional data. The data from each region is combined collectively using standard processing techniques to provide information representative of a complete, nonoverlapping image. In one version, four cameras 440 are utilized to generate four eight megapixel images that are combined through software to form a single 32 megapixel image. Surface mirrors 450 are positioned between platen 70 and cameras 440 to direct the light reflected by the skin 12a to the respective sensors 446.

In operation, device 418 is powered on via switch 58 and positioned proximate the skin 12 to be scanned with the bumpers/spacers in contact therewith to provide reproducible geometry relative to cameras 440 and at least partially block ambient external light. A scan is initiated through user interface 62. Cameras 440 are simultaneously triggered to take pictures of the skin 12a with no light emitted from light source 420 to acquire an infrared image. Controller 140 rotates filter 430 such that the ultraviolet passing filter is parallel with the skin 12a. Light source 420 is energized and ultraviolet light illuminates the skin 12a. Cameras 440 are simultaneously triggered to capture one or more images of the skin 12a to acquire an ultraviolet image. Controller 140 rotates filter 430 such that the red light passing filter is parallel with the skin 12a. Cameras 440 are simultaneously triggered to capture one or more images of the skin 12a to acquire a red light image. Controller 140 rotates filter 430 such that the blue light passing filter is parallel with the skin 12a. Cameras 440 are simultaneously triggered capture one or more images of the skin 12a to acquire a blue light image. Controller 140 rotates filter 430 such that the green light passing filter is parallel with the skin 12a. Cameras 440 are simultaneously triggered to capture one or more images of the skin 12a to acquire a green light image. The images are acquired in quick succession such that the user is unaware that multiple images were acquired. The images are communicated from cameras 440 to controller 140 where they are processed and stored as data files in memory 144. The data files remains in memory 144 until it is communicated to computer 16 or printer 146 for analysis.

Many other embodiments of the present application exist. For example, in other implementations, only some of these light wavelengths may be utilized and/or illumination may be comprised of a combination of several wavelengths across the light spectrum or just a selective wavelength or narrow range. In another example, a method of recording data includes scanning a tissue with a hand-held scanner. The hand-held scanner is separated a predetermined distance from the tissue by at least one spacer. Light is emitted from the hand-held scanner toward the tissue. At least one sensor senses the light reflected by the tissue and generates at least one sensor signal corresponding to a predetermined range of light wavelengths reflected by the tissue. The at least one signal is stored as a data file for analysis.

Another embodiment is directed to a hand-held scanner with a housing, a scanning surface along a portion of the housing, at least one disposable spacer, a control unit, memory, and a scanning mechanism including at least one illumination source and at least one sensor. The at least one illumination source emits light that is sensed by the at least one sensor to generate sensor signals. The controller is coupled with the at least one sensor that and processes the sensor signals into data. The memory is electrically coupled with the controller and stores the data as data files. The at least one disposable spacer positions the hand-held scanner a predetermined distance from a tissue.

A further embodiment includes: placing a hand-held scanner over an area of tissue, wherein a scanning surface of a hand-held scanner is separated a predetermined distance from the tissue by at least one spacer that defines a barrier to ambient light illumination of the area of tissue; emitting light from the hand-held scanner toward the tissue; sensing the light reflected by the tissue; generating at least one sensor signal corresponding to a predetermined range of wavelengths of light reflected by the tissue; and storing data from the at least one sensor signal for analysis.

In still a further embodiment, a system comprises means for placing a hand-held scanner over an area of tissue wherein a scanning surface of the hand-held scanner is separated a predetermined distance from the tissue by at least one spacer that defines a barrier to ambient light illumination of the area of tissue; means for emitting light from the hand-held scanner toward the tissue; means for sensing the light reflected by the tissue; means for generating at least one sensor signal corresponding to a predetermined range of wavelengths of light reflected by the tissue; and means for storing data from the at least one sensor signal for analysis.

Yet another embodiment includes: operating a digital image capturing device to store initial image data indicative of a bed sore condition of one or more regions of a patient's skin, which includes controlling illumination of the one or more regions of the patient's skin from a source of the digital image capturing device to reduce image variation caused by ambient light; at a later time, repeating the operating of the digital image capturing device to gather additional image data representative of the bed sore condition of the one or more regions of the patient's skin; and storing the additional image data to provide a record of the bed sore condition at the later time.

Another embodiment is directed to a digital image capturing device that includes means for storing initial image data indicative of a bed sore condition of one or more regions of the patient's skin, which includes means for controlling illumination of the one or more regions of the patient's skin; means for repetitively operating the digital image capturing device to gather additional image data representative of the bed sore condition of the one or more regions of the patient's skin, and means for storing the additional image data to update medical records information concerning the bed sore condition.

Another embodiment comprises: selecting a region of a patient's skin by engaging the patient's skin with a digital imaging device; during this engagement, at least partially shielding the region from ambient light with the digital imaging device and controlling illumination of the region with one or more illumination sources of the digital imaging device; gathering data representative of an image of the region with the digital imaging device during the illumination with the one or more illumination sources; and providing a medical record documenting condition of the region of the patient's skin based on the data.

In still another embodiment, a method comprises: selecting a region of a target object by engaging its surface with a digital imaging device; during this engagement, at least partially shielding the region from ambient light with the digital imaging device and controlling illumination thereof with one or more illumination sources of the digital imaging device; gathering data representative of an image of the region with the digital imaging device during the illumination with the one or more illumination sources; and providing a forensic examination record of the target based on the data.

A further embodiment includes a system comprising: means for selecting a region of a patient's skin by engaging the patient's skin with a digital imaging device, where the digital imaging device includes a means for at least partially shielding the region from ambient light and means for controlling illumination of the region with one or more illumination sources, means for gathering data representative of an image of the region during the illumination with the one or more sources, and means for providing a medical record to document condition of the region based on the data.

Another embodiment is directed to a system that includes a hand-held digital imaging device comprising a housing defining an optical window, an image sensor arrangement recessed in the housing and structured to selectively receive optical input through the window, a spacer structured to engage skin of a patient that defines a barrier to at least partially shield a region of the skin from ambient light external to the enclosure and establish a fixed spatial separation between the region and the image sensor arrangement when the sensor is engaged to the skin of the patient; one or more controllable light sources to illuminate the region; a controller structured to control operation of the one or more light sources and receive signals from the image sensor arrangement to provide data representative of an image of the region of the skin; and a storage device in selective communication with the controller to digitally maintain a number of medical records including medical record information documenting condition of the region of the skin of the patient based on the data.

Still a further embodiment is a system comprising a hand-held digital imaging device including a housing defining an optical window, an image sensor arrangement recessed in the housing and structured to selectively receive optical input through the window, and spacers structured to engage a surface of an image target that defines a barrier to at least partially shield a region of the target from ambient light external to the housing and establish a fixed spatial separation between the region and the image sensor arrangement when the spacer is engaged to the surface; one or more controllable light sources to illuminate the region; a controller structured to control operation of the one or more light sources and receive signals from the image sensor arrangement to provide data representative of an image of the region of the target; and a storage device in selective communication with the controller to digitally maintain a number of forensic records including forensic information to document condition of the image target based on the data.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow. In reading the claims it is intended that when words such as “a,” “an,” “at least one,” “at least a portion” are used there is no intention to limit the claim to only one item unless specifically stated to the contrary in the claim. Further, when the language “at least a portion” and/or “a portion” is used the item may include a portion and/or the entire item unless specifically stated to the contrary. While the invention has been illustrated and described in detail in the drawings and foregoing description, the same is to be considered as illustrative and not restrictive in character, it being understood that only the selected embodiments have been shown and described and that all changes, modifications and equivalents that come within the spirit of the invention as defined herein or by any of the following claims are desired to be protected.

What is claimed is:

1. A method, comprising:
placing a hand-held scanner over an area of tissue, wherein a scanning surface of the hand-held scanner is separated a predetermined distance from the tissue by at least one spacer, the spacer defining a barrier to ambient light illumination of the area of tissue;
emitting light from the hand-held scanner toward the tissue;
sensing the light reflected by the tissue;
generating at least one sensor signal corresponding to a predetermined range of wavelengths of light reflected by the tissue; and
storing data from the at least one sensor signal for analysis.

2. The method of claim 1 wherein, the data corresponds to a visible light image.

3. The method of claim 1 wherein, the data corresponds to at least one of an ultraviolet light image and an infrared light image.

4. The method of claim 1, which includes transmitting the data to a computer via at least one of wireless communication and a docking station.

5. The method of claim 1, further comprising entering supplemental data corresponding to the data file through an interface on the hand-held scanner, the supplemental data including at least one of a setting of the scanner and an identifier for the tissue.

6. The method of claim 1, which includes exchanging the at least one spacer with one or more other spacers.

7. A method, comprising:
operating a digital image capturing device, to store initial image data indicative of a bed sore condition of one or more regions of a patient's skin, which includes controlling illumination of the one or more regions of the patient's skin from a source of the digital image capturing device to reduce image variation caused by ambient light;
at a latter time, repeating the operating of the digital image capturing device to gather additional image data representative of the bed sore condition of the one or more regions of the patient's skin; and
storing the additional image data to provide a record of the bed sore condition at the later time.

8. The method of claim 7, which includes capturing infrared image information with the digital image capturing device.

9. The method of claim 7, which includes capturing ultraviolet image information with the digital image capturing device.

10. The method of claim 7, wherein the digital image capturing device includes a number of cameras.

11. The method of claim 7, wherein the operating of the digital image capturing device including moving one or more elements to scan the one or more regions.

12. The method of claim 7, which includes:
engaging the patient's skin with one or more spacers to define a fixed position of the digital image capturing device relative to the one or more regions; and
at least partially shielding the one or more regions from ambient light illumination during the engaging of the patient's skin.

13. A method, comprising:
selecting an region of a patient's skin by engaging the patient's skin with a digital imaging device;
during the engaging of the patient's skin, at least partially shielding the region from ambient light with the digital imaging device and controlling illumination of the region with one or more illumination sources of the digital imaging device;
gathering data representative of an image of the region with the digital imaging device during the illumination with the one or more illumination sources; and
providing a medical record documenting condition of the region of the patient's skin based on the data.

14. The method of claim 13, which includes:
providing one or more ultraviolet wavelengths of light from the one or more illumination sources; and
capturing ultraviolet image information in the data.

15. The method of claim 13, which includes capturing infrared image information in the data.

16. The method of claim 13, which includes selecting another region of the patient's skin to:
engage with the digital imaging device, illuminate with the one or more illumination sources, and gather corresponding image data for medical documentation.

17. The method of claim 13, which includes:
waiting a period of time;
repeating the selecting of the region, the shielding of the region, and the controlling of illumination to gather further image data representative of the region after the period of time; and
updating medical record information based on the further image data.

18. The method of claim 17, which includes comparing the further image data to the data to evaluate the condition of the region of the patient's skin.

19. The method of claim 13, which includes performing a medical diagnosis based at least in part on the data.

20. The method of claim 13, wherein the digital imaging device includes one or more spacers defining a light barrier to perform the shielding of the region.

21. A system, comprising:
a handheld digital imaging device including:
a housing defining an optical window;
an image sensor arrangement recessed in the housing and structured to selectively receive optical input through the window;
a spacer structured to engage skin of a patient, the spacer defining a barrier to at least partially shield a region of the skin from ambient light external to the housing and establish a fixed spatial separation between the region and the image sensor arrangement when the spacer is engaged to the skin of the patient;
one or more controllable light sources to illuminate the region;
a controller structured to control operation of the one or more light sources and receive signals from the image sensor arrangement to provide data representative of an image of the region of the skin; and
a storage device in selective communication with the controller to digitally maintain a number of medical records including medical record information to document condition of the region of skin of the patient based on the data.

22. The system of claim 21, wherein the hand-held digital imaging device includes an input device to receive patient identification information.

23. The system of claim 21, wherein the hand-held imaging device includes means for generating infrared image information.

24. The system of claim 21, wherein the hand-held imaging device includes means for generating ultraviolet image information.

25. The system of claim 21, wherein the hand-held imaging device includes one of:
(a) one or more elements driven by a motor to optically scan the region; and
(b) the image sensing arrangement having several cameras each structured to generate image data about a different portion of the region.
